(19) United States
(12) Patent Application Publication
(10) Pub. No.: US 2014/0281660 A1
(43) Pub. Date: Sep. 18, 2014

(54) INFORMATION PROCESSING DEVICE, TIME ADJUSTING METHOD, AND TIME ADJUSTING PROGRAM

(71) Applicant: KABUSHIKI KAISHA TOSHIBA, Minato-ku (JP)

(72) Inventors: Masataka GOTO, Yokohama-shi (JP); Nobuhiko SUGASAWA, Shinagawa-ku (JP); Yuta KOBAYASHI, Kawasaki-shi (JP); Haruhiko AKIYAMA, Koganei-shi (JP)

(73) Assignee: KABUSHIKI KAISHA TOSHIBA, Minato-ku (JP)

(21) Appl. No.: 14/178,647

(22) Filed: Feb. 12, 2014

(30) Foreign Application Priority Data
Mar. 15, 2013 (JP) 2013-053455

(51) Int. Cl. G06F 1/14

(52) U.S. Cl. CPC G06F 1/14
USPC 713/503

(57) ABSTRACT

One embodiment provides an information processing device which includes a clock unit, a file access unit and a setting unit. The clock unit is configured to count up an elapsed time from a prescribed reference time if an origin time has not been set, and to count up an elapsed time from the origin time if the origin time has been set. The file access unit is configured to access a file which has time information given by an external device or the information processing device. The file is stored in a storage device. The setting unit is configured to acquire the time information from the file via the file access unit, and to set the acquired time information into the clock unit as the origin time.

### CROSS-REFERENCE TO RELATED APPLICATION(S)

This application claims priority from Japanese Patent Application No. 2013-053455 filed on Mar. 15, 2013, the entire contents of which are incorporated herein by reference.

### FIELD

Embodiments described herein relate generally to an information processing device, a time adjusting method, and a time adjusting program.

### BACKGROUND

In recent years, one-chip computer systems have been realized as embedded systems have been increased in functionality and integration density. One-chip computer systems are configured such that a CPU, a main memory, interfaces for connections to peripheral devices, etc. are provided in a several millimeter square chip. Incorporating software including an operating system (OS), such one-chip computer systems can perform even complex processing.

The OS has a clock function. Such clock function provides a clock that counts up at regular time intervals starting from a predetermined initial value. An example of the predetermined initial value is the POSIX epoch (Jan. 1, 1970 of Coordinated Universal Time). The OS clock function returns to the initial state when the computer system is powered off. Therefore, once the computer system is powered off, the OS clock function may start counting from Jan. 1, 1970 to show wrong time when the computer system is booted next time.

Computer systems may be equipped with a realtime clock (RTC) separately from the OS clock function. Such RTC is implemented by hardware, and incorporates a battery. Since the battery is incorporated, the RTC can continue to tick without being affected by the power state of the computer system. The OS clock function may be enabled to show correct time by accruing a current time from the RTC and setting it as its initial value everytime the computer system is booted.

However, the RTC needs to be supplied with power from a battery or the like and is large in size. With the recent miniaturization of embedded devices, some embedded devices may not be able to incorporate such RTC. In such a case, a proper origin time cannot be set in the clock function when the OS is booted and hence the clock function cannot show correct time. If the clock function does not show correct time, wrong dates and times are used as date and time information of an operation log, file generation date and time information, etc.

As another technique, the OS may be configured to synchronize its own clock function with the time of a clock of another device through communication. Examples of this method are NTP (Network Time Protocol) and TCP daytime. However, to realize this technique, both of the subject device and a counterpart device should be equipped with a communication means.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a block diagram of a system including an information processing device 100 according to a general embodiment.

FIG. 2 is a block diagram of a system including an information processing device 200 according to a first embodiment.

FIG. 3 shows an example file system structure of a flash memory 206.

FIG. 4 shows an operation sequence of the system shown in FIG. 2.

FIG. 5 is a block diagram of a system including an information processing device 500 according to a second embodiment.

FIG. 6 shows an operation sequence of the system shown in FIG. 5.

FIG. 7 is a block diagram of a system including an information processing device 700 according to a third embodiment.

FIG. 8 shows an operation sequence of the system shown in FIG. 7.

FIG. 9 shows an example of triggering by completion of access from the host terminal 800.

FIG. 10 is a block diagram of a system including an information processing device 700 according to a fourth embodiment.

FIG. 11 shows an operation sequence of the system shown in FIG. 10.

### DETAILED DESCRIPTION

One embodiment provides an information processing device, including: a clock unit configured to count up an elapsed time from a prescribed reference time if an origin time has not been set, and to count up an elapsed time from the origin time if the origin time has been set; a file access unit configured to access a file which has time information given by an external device or the information processing device, the file being stored in a storage device; and a setting unit configured to acquire the time information from the file via the file access unit, and to set the acquired time information into the clock unit as the origin time.

Several embodiments will be described with reference to the drawings. The same constituent elements shown in the drawings are given the same reference symbol and will not be described redundantly.

FIG. 1 is a block diagram of a system including an information processing device 100 according to a general embodiment.

The information processing device 100 is equipped with a time information setting unit 101, a clock unit 102, a file access unit 103, a storage access unit 104 and an external terminal IF (interface) 105.

The system shown in FIG. 1 includes an external terminal 110, the information processing device 100 and a storage 106 (storage device).

The information processing device 100 can access the storage 106 through the storage access unit 104.

The information processing device 100 can communicate with the external terminal 110 through the external terminal IF 105. The external terminal 110 is a device which is equipped with a realtime clock (RTC) or the like and hence can provide accurate time. The information processing device 100 receives a file generated by the external terminal 110 through the external terminal IF 105. The information processing device 100 performs processing of writing the received file to the storage 106 using the file access unit 103 and the storage access unit 104.

The external terminal 110 accesses a file stored in the storage 106 via the external terminal IF 105, the file access unit 103, and the storage access unit 104 of the information processing device 100. In generating or accessing a file, the external terminal 110 attaches an accurate time generated by itself to the file.

The storage 106 (described later in detail) is an HDD, an SSD, a flash memory card, or the like. The storage 106 stores a file(s) which has time information (described later in detail) given by the external terminal 110 or the information processing device 100 itself.

The clock unit 102 operates while it is supplied with power (powered on), and stops operating while it is not supplied with power (powered off). The clock unit 102 is in many cases implemented by software such as an OS or firmware, and may be implemented by hardware. In the case of rebooting after power-off, if an origin time has not been set, the clock unit 102 counts up at regular time intervals to show an elapsed time from a prescribed reference time. If an origin time has been set, the clock unit 102 counts up at regular time intervals to show an elapsed time from the origin time. An example of the predetermined reference time is the POSIX epoch (Jan. 1, 1970 of Coordinated Universal Time).

The time information setting unit 101 acquires the time information held by the file via the file access unit 103 and the storage access unit 104, and sets the time indicated by the acquired time information in the clock unit 102 as an origin time. The origin time is a time to serve as the origin of counting-up that is done by the clock unit 102 after its setting by the time information setting unit 101.

The file access unit 103 accesses the file via the storage access unit 104. For example, access to a file means writing or reading information to or from the file. The file access unit 103 acquires, for example, time information in the file by reading the file. When having accessed the file, the file access unit 103 updates a time stamp (described later) on the basis of a time shown by the clock unit 102.

The storage access unit 104 is an interface which accesses the file stored in the storage 106 according to an instruction from the file access unit 103. For example, the storage access unit 104 is a storage interface of an HDD, an SSD, a flash memory card, or the like or a general-purpose communication interface capable of connecting to a device having a storage. A specific description will be made of each case later.

For example, the embodiment realizes an OS (operating system) clock function which shows correct time even in the case where the information processing device 100 is equipped with neither an RTC nor a communication means for time synchronization with another device, by acquiring, from a file, time information that was attached to the file by the external terminal 110 which provides accurate time and setting the time indicated by the acquired time information in the clock unit 102.

Specific examples of the above information processing device 100 according to several embodiments will be described below.

### Embodiment 1

FIG. 2 is a block diagram showing the configuration of a system including an information processing device 200 according to a first embodiment. The system described in the first embodiment is a system in which the storage 106 shown in FIG. 1 is a flash memory 206.

The information processing device 200 is equipped with a time information setting unit 101, a clock unit 102, a file system control unit 203, a flash memory control unit 204, and an external terminal IF 105.

The file system control unit 203 is an example of the file access unit 103 shown in FIG. 1. The file system control unit 203 accesses a file stored in the flash memory 206 which is a local storage via the flash memory control unit 204. For example, access to a file means writing or reading information to or from the file. The file system control unit 203 acquires, for example, time information in the file.

The flash memory control unit 204 is an example of the storage access unit 104 shown in FIG. 1. The flash memory control unit 204 accesses the flash memory 206 according to an instruction from the file system control unit 203.

The time information setting unit 101 acquires the time information held by the file via the file system control unit 203 and the flash memory control unit 204, and sets the time indicated by the acquired time information in the clock unit 102 as an origin time. For example, the time information is given as a time stamp of the file (e.g., a file last update date and time, a file last access date and time, or a file generation date and time). As another example, the time information may be included in the body of the file. The time information setting unit 101 may acquire both of the time information of the time stamp of the file and the time information included in the body of the file. When the time information setting unit 101 has acquired plural time information (e.g., plural ones of a file last update date and time, a file last access date and time, a file generation date and time, and time information included in the body of the file), it is preferable to set time information indicating a latest time among the acquired plural time information as an origin time of the clock unit 102. Where plural files are stored in the flash memory 206, the time information setting unit 101 may acquire plural time information from the plural files. In this case, it is preferable to set time information indicating a latest time among the acquired plural time information as an origin time of the clock unit 102.

Next, a description will be made of the structure of a file system of the flash memory 206, whereby a time stamp of a file and time information included in the body of the file will be described. FIG. 3 shows an example file system structure of the flash memory 206. In the flash memory 206, a file management structure is constructed by dividing its physical storage space into logical structure items shown in FIG. 3. This file management structure is called a file system. FIG. 3 shows a typical example manner of division into logical structure items. In the example of FIG. 3, the logical structure items are a master boot record, a file allocation table, and a data block.

The master boot record is an area where program code that is necessary for booting the system including the information processing device 200 and the flash memory 206 is held.

The file allocation table is an area where use or non-use of each sector of the data block is indicated (the sectors are managed such that plural sectors are combined into a unit called a cluster).

The data block is an area where directory entries and file bodies are held.

The directory entry is a management unit for holding of file information and directory information that are held in the directory, examples of which are a file name, a file attribute, a size, a time stamp, and a head cluster of a file body. Various other kinds of information may be held depending on the kind of file system.

A root directory exists at the head of directories having a tree structure. FIG. 3 exemplifies the case where a file “/.ctrl/hogehoge” is held by the flash memory 206. In FIG. 3, structures of a root directory (denoted by “/”), a .ctrl directory, and a hogehoge file are shown. The “file attribute” has a default value depending on the kind of file system. In the example of FIG. 3, a value “0x10” means that this directory entry is of a directory. A value “0x0” means that this directory entry has no attribute (i.e., it is of a file). The “size” indicates a data length of the file body in the case where the directory entry is of a file. In this example, the size of a directory is fixed to “0.”

Typical examples of the “time stamp” are a generation date and time, a last update date and time, and a last access date and time. The generation date and time is a date and time when the file or directory was generated.

The last update date and time is a date and time when the file body or directory entry was updated last.

The last access date and time is a date and time when the file body or directory entry was accessed (e.g., read) last.

The data block is stored with the file body of each file having a directory entry. The term “file body” means data itself of image data, document data, or the like. As described later in detail, a file body may hold time information.

FIG. 4 shows an operation sequence of the system shown in FIG. 2.

At step S101, an operation start instruction is input to the time information setting unit 101 using, as a trigger, power-on (step S100) of the system (which includes the information processing device 200 and the flash memory 206), for example. At steps S102, S103, and S104, the time information setting unit 101 acquires time information of a file via the file system control unit 203. The time information setting unit 101 acquires time information of a file via the file system control unit 203 and the flash memory control unit 204 using a file access API such as a stat( ) system call. For example, time information of a file includes time stamp information held by a directory entry.

At steps S105 and S106, the time information setting unit 101 reads the time of the acquired time information and sets it in the clock unit 102. The time information setting unit 101 may either acquire plural time information from all of the files stored in the flash memory 206 or acquire time information from a particular file. When having acquired plural time information, time information setting unit 101 sets a time in the clock unit 102 using time information having a latest time.

The time information setting unit 101 may acquire, as time information of a file, time information that exists in the file body. For example, in the case of a photograph image file of a digital camera, image data may be added with a photographing date and time. For example, in such a standard as EXIF (exchangeable image file format), image data is added with a photographing date and time. In such a case, the photographing date and time may be acquired as time information. There may be a case that time information exists in a file body in the form of “time: 2013/02/01 13:05:15,” for example, according to a format prescribed by the system. The time information setting unit 101 may acquire such time information.

The clock unit 102 ticks as it counts up from the time that has been set on the basis of the time information.

As described above, in the information processing device 200 according to the first embodiment, the system including the information processing device 200 sets, in the clock unit 102, the time indicated by time information that is attached to a file, whereby the OS clock function can show correct time.

### Embodiment 2

FIG. 5 is a block diagram showing the configuration of a system including an information processing device 500 according to a second embodiment. The system described in the second embodiment is equipped with a terminal 600 which can communicate with the information processing device 500. The information processing device 500 can access a flash memory 206 via the terminal 600.

The information processing device 500 is equipped with a time information setting unit 101, a clock unit 102, a file access protocol unit 503, a communication IF 504, and an external terminal IF 105.

The file access protocol unit 503 corresponds to the file access unit 103 which was described above with reference to FIG. 1. The file access protocol unit 503 accesses a file stored in the flash memory 206 by communicating with the terminal 600 via the communication IF 504. Various file access protocols such as FTP (RFC 959), HTTP (RFC 2616), and OBEX (object exchange) are available, and the file access protocol unit 503 employs a protocol determined by the system. FIG. 6 shows an operation sequence of a case that OBEX is used as a file access protocol.

The communication IF 504 corresponds to the storage access unit 104 which was described above with reference to FIG. 1. The communication IF 504 communicates with the terminal 600.

Next, an operation sequence of the system shown in FIG. 5 will be described with reference to FIG. 6.

First, at steps S202 and S203, the time information setting unit 101 issues a file list request via the file access protocol unit 503 in response to a design-defined trigger (S201) such as a user manipulation or a start of a communication. In OBEX, a file list request is a message “GET, Type=x-obex/folder-listing.” Receiving this message, at steps S204, S205, and S206 a file server protocol unit 602 of the terminal 600 acquires a directory entry of the flash memory 206 via a file system control unit 603.

At step S207, the file server protocol unit 602 sends the acquired directory entry to the file access protocol unit 503 via a communication IF 602. In OBEX, the file server protocol unit 602 sends a message in which name=fileA, size=xx, modified=[time stamp], created=[time stamp], accessed=[time stamp]. In an actual communication channel, a binary-encoded message is sent. A protocol used should be followed. At steps S208, S209, and S210, the time information setting unit 101 reads time information from a received file list and sets an origin time in the clock unit 102. The clock unit 102 starts to count up from the thus-set origin time.

As described above, in the information processing device 500 according to the second embodiment, the system including the information processing device 500 sets, in the clock unit 102, the time indicated by time information that is attached to a file, whereby the OS clock function can show correct time.

### Embodiment 3

FIG. 7 is a block diagram of a system including an information processing device 700 according to a third embodiment. Unlike the systems described in the first and second embodiments, the system shown in FIG. 7 is equipped with a host terminal 800.

The information processing device 700 is equipped with a time information setting unit 101, a clock unit 102, a file system control unit 203, a flash memory control unit 204, an external terminal IF 105, and a host IF 705.

The information processing device 700 is recognized as a storage, more specifically, a removable medium, by the host terminal 800 via the host IF 705. The host terminal 800 is a smartphone, a tablet PC, or the like.

The host terminal 800 makes file access (data reading/writing (block access)) via the host IF 705. For example, the host IF 705 is compatible with USB (universal serial bus) or the SD memory. In the case of USB, a standard called USB MSC (mass storage class) is employed typically.

Triggered by completion of access to a file stored in the flash memory 206 by the host terminal 800 via the host IF 705, the time information setting unit 101 acquires time information by causing the file system control unit 203 to access the file stored in the flash memory 206. The time information setting unit 101 can detect an event that the host terminal 800 has completed access to a file stored in the flash memory 206 by the host IF 708's receiving a message that is sent from the host terminal 800 and allows removal of the information processing device 700 from the host terminal 800. As described later in detail, the message that is sent from the host terminal 800 and allows removal of the information processing device 700 from the host terminal 800 is, for example, a message “PREVENT ALLOW MEDIUM REMOVAL command (prevent flag=allowed).

Next, an operation sequence of the system shown in FIG. 7 will be described with reference to FIG. 8.

At step S300, the host terminal 800 accesses (data reading/writing (block access)) a file via the host IF 705 and the flash memory control unit 204. Upon completion of the access (triggered by the completion of the access (step S301)), at step S302 the time information setting unit 101 starts its operation. Steps S303-S307 at which the time information setting unit 101 acquires time information from a time stamp of the file or a file body and setting a time in the clock unit 102 are the same as steps S102-S106 shown in FIG. 4 and hence will not be described.

Next, a description will be made of how the time information setting unit 101 detects completion of access from the host terminal 800 (shown in FIG. 8).

FIG. 9 shows an example of triggering by completion of access from the host terminal 800 (a case of USB MSC). In starting access to the flash memory 206, the host terminal 800 issues a message a message “PREVENT ALLOW MEDIUM REMOVAL command (prevent flag=prohibited). On the other hand, upon completion of the access, the host terminal 800 issues a message a message “PREVENT ALLOW MEDIUM REMOVAL command (prevent flag=allowed). Strictly, the OS of the host terminal 800 behaves somewhat differently depending of its type and hence it is necessary to determine a trigger accordingly. The time information setting unit 101 can start its operation being triggered by reception, by the host IF 705, of a message indicating completion of the access.

In the information processing device 700 according to the third embodiment, the time indicated by time information that has been attached to a file by the host terminal 800 is set in the clock unit 102, whereby the OS clock function can show correct time. In particular, in this embodiment, a more accurate time can be set because the time information setting unit 101 acquires time information from a file using, as a trigger, completion of access to the file by the host terminal 800.

FIG. 10 is a block diagram showing a system including an information processing device 1000 according to a fourth embodiment.

### Embodiment 4

The information processing device 1000 is equipped with a time information setting unit 1001, a clock unit 102, a file system control unit 203, a flash memory control unit 204, and an external terminal IF 105.

The time information setting unit 1001 has, in addition to the functions described in the first embodiment, a function of updating the time stamp information of a file that was used for setting the clock unit 102 to a current time shown by the clock unit 102, being triggered by a system shutdown or the like.

FIG. 11 is a sequence diagram showing how the system operates.

Triggered by a system shutdown, at steps S400 and S401 the time information setting unit 1001 reads out a current time of the clock unit 102. At steps S403 and S404, the time information setting unit 1001 updates the time information of a file to the current time acquired from the clock unit 102 using an API for updating the time stamp of a file, such as a utime( ) system call.

When the system is rebooted, the time information setting unit 1001 can acquire time information from the file whose time stamp was updated to a time read from the clock unit 102 at steps S401-S404 and set the time indicated by the acquired time information as an origin time of the clock unit 102.

In the information processing device 1000 according to the fourth embodiment, a time shown by the clock unit 102 is given to (stored in) a file. Then, time information is acquired from the file and the time indicated by the acquired time information is set in the clock unit 102. This allows the OS clock function to show correct time.

The above-described embodiments provide the advantage that the OS clock function is allowed to show correct time even in the case where the information processing device (100) is equipped with neither an RTC nor a communication means for time synchronization with another device.

Some of the above-described methods for acquiring time information from a file may be combined together, in which case they may be executed in arbitrary order.

For example, the information processing device 100 can be implemented by using a general-purpose computer as basic hardware. That is, the time information setting unit 101, the clock unit 102, the file access unit 103, the storage access unit 104, and the external terminal IF can be implemented by causing a processor of the computer to run programs. The programs may be previously installed in the computer. Alternatively, the programs may be installed into the computer as necessary from a storage medium which stores the programs or via a network.

Although the several embodiments have been described, they are just examples and should not be construed as restricting the scope of the invention. Each embodiment may be embodied in various other forms. For example, a part of each embodiment may be omitted, replaced by other elements, or changed in various manners without departing from the spirit and scope of the invention. These modifications will also fall within the scope of the invention.

1. An information processing device, comprising:
a clock unit configured to count up an elapsed time from a prescribed reference time if an origin time has not been set, and to count up an elapsed time from the origin time if the origin time has been set;
a file access unit configured to access a file which has time information given by an external device or the information processing device, the file being stored in a storage device; and
a setting unit configured to acquire the time information from the file via the file access unit, and to set the acquired time information into the clock unit as the origin time.

2. The information processing device of claim 1,
wherein the file has plural time information, and
wherein the setting unit acquires the plural time information, and sets time information indicating a latest time among the acquired plural time information into the clock unit as the origin time.

3. The information processing device of claim 1,
wherein plural files are stored in the storage device, and
wherein the setting unit acquires plural time information from the plural files via the file access unit, and sets time information indicating a latest time among the acquired plural time information into the clock unit as the origin time.

4. The information processing device of claim 1,
wherein the time information is one of a last update date and time of the file, a last access date and time of the file, and a file generation date and time of the file which are given as time stamps of the file.

5. The information processing device of claim 1,
wherein the time information is included in a body of the file.

6. The information processing device of claim 2,
wherein the time information is one of a last update date and time of the file, a last access date and time of the file, and a file generation date and time of the file which are given as time stamps of the file and included in a body of the file.

7. The information processing device of claim 1, further comprising:
a storage access unit configured to access the storage device,
wherein the file access unit accesses the file via the storage access unit.

8. The information processing device of claim 1, further comprising:
a communication interface configured to communicate with a terminal,
wherein the storage device is configured to be accessible from the terminal, and
wherein the file access unit accesses the file by communicating with the terminal via the communication interface.

9. The information processing device of claim 1, further comprising:
a host interface configured to communicate with an external host terminal,
wherein the setting unit acquires the time information from the file via the file access unit upon completion of access to the file stored in the storage device by the host terminal via the host interface.

10. The information processing device of claim 1, further comprising:
a host interface configured to communicate with an external host terminal,
wherein the setting unit acquires the time information from the file via the file access unit upon receipt of a message at the host interface, the message indicating that removal of the information processing device from the host terminal is allowed.

11. The information processing device of claim 3,
wherein, before power-off of the clock unit, the setting unit reads out a time shown by the clock unit and updates time information of at least one of the plural files to the read-out time.

12. A time adjusting method for adjusting time of a clock unit which counts up an elapsed time from a prescribed reference time if an origin time has not been set and which counts up an elapsed time from the origin time if the origin time has been set, the method comprising:
a file access step of accessing a file which has time information given by an external device or a self device, the file being stored in a storage device; and
a setting step of acquiring the time information from the file through execution of the file access step, and setting the acquired time information in the clock unit as the origin time.

13. A computer-readable medium storing a time adjusting program realizes:
a clock function configured to count up an elapsed time from a prescribed reference time if an origin time has not been set, and to count up an elapsed time from the origin time if the origin time has been set;
a file access function configured to access a file which has time information given by an external device or the information processing device, the file being stored in a storage device; and
a setting function configured to acquire the time information from the file via the file access function, and to set the acquired time information into the clock function as the origin time.
